(19) United States
(12) Patent Application Publication
(10) Pub. No.: US 2025/0265770 A1
(43) Pub. Date: Aug. 21, 2025

(54) METHOD, SERVER, AND COMPUTER PROGRAM FOR GENERATING CUBE MAP THROUGH PLURALITY OF IMAGES RELATED TO MULTIPLE VIEWPOINTS

(71) Applicant: REBUILDERAI INC., Seongnam-si (KR)

(72) Inventors: Geunho JUNG, Namyangju-si (KR); Jeonghyeon KIM, Suwon-si (KR); Kyuyeol PARK, Seongnam-si (KR)

(73) Assignee: REBUILDERAI INC., Seongnam-si (KR)

(21) Appl. No.: 19/203,630

(22) Filed: May 9, 2025

Related U.S. Application Data
(63) Continuation of application No. PCT/KR2023/013954, filed on Sep. 15, 2023.

(30) Foreign Application Priority Data
Nov. 10, 2022 (KR) 10-2022-0149802
Nov. 11, 2022 (KR) 10-2022-0150386

(51) Int. Cl. G06T 15/20; G06T 7/593

(52) U.S. Cl. CPC G06T 15/205; G06T 7/593; G06T 2207/10012; G06T 2207/20081; G06T 2207/20084

(57) ABSTRACT

Disclosed is a method for generating a cube map through a plurality of images related to multiple viewpoints. The method is performed in one or more processors of a computing device, and may include: obtaining a plurality of images captured from multiple viewpoints focusing on a specific object; obtaining an object mask corresponding to each of the images and camera information through preprocessing of each of the plurality of images; obtaining a plurality of background images corresponding to each of the plurality of images on the basis of the object mask corresponding to each of the images; obtaining depth information on the basis of the plurality of background images and camera information corresponding to each of the background images; and obtaining a cube map on the basis of the plurality of background images, the camera information corresponding to each of the background images, and the depth information.

### CROSS REFERENCE TO RELATED APPLICATION

The present application is a continuation of International Patent Application No. PCT/KR 2023/013954, filed on Sep. 15, 2023, which is based upon and claims the benefit of priority to Korean Patent Application No. 10-2022-0149802, filed Nov. 10, 2022, and Korean Patent Application No. 10-2022-0150386, filed Nov. 11, 2022, the entire contents of which are incorporated herein for all purposes by this reference.

### TECHNICAL FIELD

Various embodiments of the present invention relate to a method of generating a cube map related to three-dimensional (3D) rendering, and more particularly, to a method, server, and computer program for generating a cube map on the basis of a plurality of images related to multiple viewpoints.

### BACKGROUND ART

In computer graphics, image-based lighting methods are used to render a three-dimensional (3D) space efficiently and realistically. According to the image-based lighting methods, a surrounding environment is stored as a texture image to approximate the reflectivity of a surface of a rendered object (or objects), and the texture image is utilized to efficiently and rapidly calculate a reflection characteristic.

In this case, the texture image is a two-dimensional (2D) spread of space in the form of a cube map or sphere map, rather than a general image, and is utilized by mapping pixel values acquired when rays emitted from a camera facing an object are reflected back to the cube map.

Meanwhile, a cube map or sphere map may be generated from a 360° image or a panoramic image rather than a general image or using an image stitching technique.

However, 360° images or panoramic images may be inaccessible to general users without specialized hardware because it is necessary to acquire the images by utilizing specialized hardware, such as a camera with a specialized lens, that is, a fisheye lens or the like, or two or more lenses, or by stitching images acquired through a multi-view camera.

Accordingly, in the art, there may be demand for research and development on an algorithm for generating a cube map image for sphere mapping from multi-view images taken through a general camera.

### Conventional Art Document

### Patent Document

Korean Patent Publication No. 10-2019-0051901 (May 16, 2019)

### DISCLOSURE

### Technical Problem

Objects to be solved by the present invention are derived on the basis of the background art described above, and the present invention is directed to providing a method of generating a cube map on the basis of images acquired through a general camera.

Objects to be solved by the present invention are not limited to that described above, and other objects that have not been described will be clearly understood by those of ordinary skill in the art from the following description.

### Technical Solution

One aspect of the present invention provides a method of generating a cube map from a plurality of images related to multiple viewpoints. The method performed by at least one processor of a computing device may include acquiring a plurality of images taken from various viewpoints with a specific object centered, acquiring an object mask and camera information corresponding to each of the plurality of images through preprocessing of the image, acquiring a plurality of background images each corresponding to the plurality of images on the basis of the object mask corresponding to each of the images, acquiring depth information on the basis of the plurality of background images and camera information corresponding to each of the background images, and acquiring a cube map on the basis of the plurality of background images, the camera information corresponding to each of the background images, and the depth information.

The plurality of images may include multiple viewpoint images acquired by utilizing one camera, and each of the images may be an image taken to at least partially overlap adjacent images related to adjacent viewpoints.

The acquiring of the object mask and the camera information corresponding to each of the plurality of images through the preprocessing of the image may include extracting a feature point from each of the plurality of images, matching the extracted feature point with an adjacent image, acquiring initial camera information corresponding to each of the images on the basis of the matching points, and optimizing the initial camera information to acquire the camera information corresponding to each of the images.

The acquiring of the object mask and the camera information corresponding to each of the plurality of images through the preprocessing of the image may include extracting an object mask related to the specific object from each of the images by utilizing an algorithm based on deep learning.

The acquiring of the depth information on the basis of the plurality of background images and the camera information corresponding to each of the background images may include extracting depth information corresponding to each of the background images by utilizing a multi-view stereo (MVS) algorithm, and the depth information may include information related to distances from a camera to objects included in each of the images.

The acquiring of the cube map may include projecting the plurality of background images to a three-dimensional (3D) space on the basis of the camera information corresponding to each of the background images and the depth information and acquiring the cube map on the basis of the plurality of background images projected to the 3D space.

The acquiring of the cube map on the basis of the plurality of background images projected to the 3D space may include converting coordinates corresponding to each point in the 3D space into spherical coordinates corresponding to a spherical coordinate system and generating a cube map on the basis of the spherical coordinates of each point and a pixel value corresponding to the point.

The method may further include correcting the cube map, and the correcting of the cube map may include identifying a missing region in the cube map and calculating missing pixel values on the basis of adjacent pixel values of the missing region and complementing the missing region using the missing pixel values.

Another aspect of the present invention provides a server for performing the method of generating a cube map from a plurality of images related to multiple viewpoints, the server including a memory configured to store one or more instructions and a processor configured to execute the one or more instructions stored in the memory. By executing the one or more instructions, the processor may perform the method of generating a cube map from a plurality of images related to multiple viewpoints.

Another aspect of the present disclosure provides a computer-readable recording medium. The computer-readable recording medium may store a program for executing, in combination with hardware, a method of generating a cube map from a plurality of images related to multiple viewpoints.

Other details of the present invention are included in the detailed description and drawings.

### Advantageous Effects

According to various embodiments of the present invention, it is possible to provide a method of generating a cube map on the basis of images acquired through a general camera. Accordingly, it is possible to render an actual environment more realistically by applying image-based lighting without the additional costs of specialized hardware and provide the effect of further advancing a three-dimensional (3D) transformation module in which a reflection characteristic is taken into consideration.

Effects of the present invention are not limited that described above, and other effects which have not been described will be clearly understood by those of ordinary skill in the art.

### DESCRIPTION OF DRAWINGS

FIG. 1 is a schematic exemplary diagram of a system for implementing a method of generating a cube map from a plurality of images related to multiple viewpoints according to an embodiment of the present invention.

FIG. 2 is a hardware configuration diagram of a server for performing the method of generating a cube map from a plurality of images according to an embodiment of the present invention.

FIG. 3 is a flowchart illustrating a method of generating a cube map from a plurality of images according to the embodiment of the present invention.

FIG. 4A is a set of exemplary views illustrating a plurality of images according to the embodiment of the present invention.

FIG. 4B is a set of exemplary views illustrating object masks corresponding to each of the images according to the embodiment of the present invention.

FIG. 4C is a set of exemplary views illustrating depth information calculated for each of the plurality of images according to the embodiment of the present invention.

FIG. 4D is a set of exemplary views illustrating depth information calculated for each of background images according to the embodiment of the present invention.

FIG. 5 is an exemplary view illustrating a cube map according to the embodiment of the present invention.

FIG. 6 is an exemplary diagram illustrating the entire process of generating a cube map on the basis of a plurality of images according to the embodiment of the present invention.

FIG. 7 is a flowchart illustrating a method of recognizing an object of interest on the basis of multi-view images according to an embodiment of the present invention.

FIG. 8 is a set of exemplary views illustrating a plurality of images included in multi-view images according to the embodiment of the present invention.

FIG. 9 is an exemplary diagram illustrating the process of selecting reference images among multi-view images according to the embodiment of the present invention.

FIG. 10 is an exemplary diagram illustrating the process of correcting an object-of-interest region extracted from multi-view images according to the embodiment of the present invention.

FIG. 11 is an exemplary diagram illustrating the process of generating a cost volume on the basis of reference images and setting a final object-of-interest region on the basis of the cost volume according to the embodiment of the present invention.

FIG. 12 is a schematic diagram illustrating one or more network functions according to an embodiment of the present invention.

### BEST MODE OF THE INVENTION

Hereinafter, various embodiments will be described with reference to the drawings. In the present specification, various descriptions are presented to aid in understanding of the present invention. However, it is apparent that these embodiments can be executed without the specific descriptions.

The terms “component,” “module,” “system,” and the like used in the specification designate a computer-related entity, hardware, firmware, software, a combination of software and hardware, or execution of software. For example, a component may be, but is not limited to, a processing procedure executed on a processor, an object, an execution thread, a program, and/or a computer. For example, both an application executed in a computing device and the computing device may be components. One or more components may reside in a processor and/or execution thread. One component may be localized in one computer. One component may be distributed among two or more computers. Further, these components may be executed by various computer-readable media having various data structures stored therein. Components may perform communication through local and/or remote processing in accordance with a signal (e.g., data from one component interacting with another component in a local system or a distributed system and/or data transmitted to another system through a network, such as the Internet, using a signal) having one or more data packets.

The term “or” is intended to mean comprehensive “or,” not exclusive “or.” In other words, unless otherwise specified or when it is unclear in context, “X uses A or B” is intended to mean one of the natural comprehensive substitutions. That is, “X uses A or B” may be applied to any one of the cases where X uses A, X uses B, and X uses both A and B. Further, the term “and/or” used in the present specification should be understood as designating and including all possible combinations of one or more items among listed relevant items.

The term “include” and/or “including” should be understood as meaning that a corresponding characteristic and/or component exists. However, it should be understood that the existence or addition of one or more other characteristics, components, and/or a group thereof is not excluded. Further, unless otherwise specified or when it is unclear that a single form is indicated in context, the singular form should be generally construed as meaning “one or more” in the present specification and the claims.

Those of ordinary skill in the art should recognize that various illustrative logical blocks, configurations, modules, circuits, means, logic, and algorithm operations described in relation to the embodiments additionally disclosed herein may be implemented by electronic hardware, computer software, or a combination thereof. To clearly illustrate interchangeability of hardware and software, the various illustrative components, blocks, configurations, means, logic, modules, circuits, and operations have been generally described above in the functional aspects thereof. Whether the functionality is implemented as hardware or software depends on a specific application or design restraints given to the overall system. Those skilled in the art may implement the described functionality for each of specific applications using various methods. However, determinations of the implementation should not be construed as deviating from the scope of the present invention.

The description of the presented embodiments is provided for those skilled in the art to use or implement the present invention. Various modifications of the embodiments will be apparent to those skilled in the art. General principles defined herein may be applied to other embodiments without departing from the scope of the present invention. Accordingly, the present invention is not limited to the embodiments presented herein. The present invention should be interpreted within the broadest meaning range consistent with the principles and new characteristics presented herein.

In the present specification, a computer is any kind of hardware device including at least one processor and, according to embodiments, may be understood as also including a software configuration that operates on a corresponding hardware device. For example, a computer may be understood as including, but is not limited to, a smartphone, a tablet personal computer (PC), a desktop, a laptop, and a user client and applications that run on each device.

Hereinafter, embodiments of the present invention will be described in detail with reference to the accompanying drawings.

While the operations described in the present specification are described as being performed by a computer, an entity that performs each operation is not limited thereto, and at least parts of operations may be performed by different devices according to embodiments.

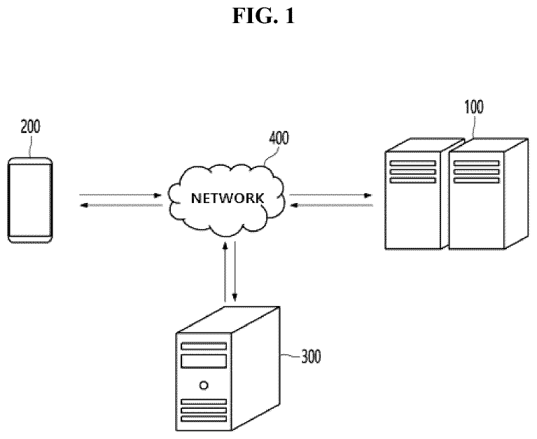

FIG. 1 is a schematic exemplary diagram of a system for implementing a method of generating a cube map from a plurality of images related to multiple viewpoints according to an embodiment of the present invention.

As shown in FIG. 1, the system according to embodiments of the present invention may include a server 100, a user terminal 200, an external server 300, and a network 400. The components shown in FIG. 1 are illustrative, and there may be additional components, or some of the components shown in FIG. 1 may be omitted. The server, 100, the external server 300, and the user terminal 200 according to embodiments of the present invention may transmit and receive data to and from each other for the system according to embodiments of the present invention via the network 400.

The network 400 according to embodiments of the present invention may employ various wired communication systems such as a public switched telephone network (PSTN), an x digital subscriber line (xDSL), a rate adaptive DSL (RADSL), a multi-rate DSL (M DSL), a very high speed DSL (VDSL), a universal asymmetric DSL (UUADSL), a high bit rate DSL (HDSL), a local area network (LAN), and the like.

Also, the network 400 presented herein may employ various wireless communication systems such as a code division multiple access (CDMA) system, a time division multiple access (TDM A) system, a frequency division multiple access (FDM A) system, an orthogonal frequency division multiple access (OFDM A) system, a single carrier (SC)-FDMA system, and other systems.

The network 400 according to embodiments of the present invention may be constructed using any communication modality, such as wired communication, wireless communication, and the like, and may be configured as various communication networks such as a personal area network (PAN), a wide area network (WAN), and the like. Also, the network 400 may be the well-known World Wide Web (WWW) and may employ a wireless transmission technique used for short-range communication such as Infrared Data Association (IrDA) or Bluetooth. Technologies described in the present specification may be used in not only the foregoing networks but also other networks.

According to the embodiment of the present invention, the server 100 for providing a method of generating a cube map from a plurality of images related to multiple viewpoints (hereinafter “server 100”) may generate a cube map on the basis of a plurality of images.

Specifically, the server 100 may acquire a plurality of images related to multiple viewpoints to perform preprocessing and may generate a cube map on the basis of the plurality of preprocessed images. Here, the plurality of images related to multiple viewpoints may be a plurality of images taken from various viewpoints with a specific object centered. In particular, the plurality of images related to multiple viewpoints may be images that are taken to at least partially overlap each other. Also, a cube map may be texture in which surroundings of a viewpoint may be rendered and stored in advance. For example, a cube map may be texture including screen data that expresses scenes around an object as if the object was at the center of a cube. Such a cube map may be utilized during the process of rendering a three-dimensional (3D) space efficiently and realistically. In other words, the server 100 may generate a cube map that is utilized during a 3D rendering process, on the basis of a plurality of images acquired through imaging based on a specific object from various viewpoints.

According to the embodiment, preprocessing the plurality of images may include preprocessing for acquiring an object mask related to the specific object included in each image and preprocessing for acquiring camera information (e.g., a camera pose, camera parameter information, and the like) corresponding to each image.

According to the embodiment, the server 100 may acquire an object mask related to the specific mask from each image by utilizing a deep learning-based algorithm. Here, the deep learning-based algorithm may be a neural network model (e.g., a convolutional neural network (CNN) model) trained to acquire an object related to a specific object from an image.

In addition, according to the embodiment, the server 100 may calculate camera information corresponding to each image using a structure from motion (SfM) algorithm. The SfM algorithm may be an algorithm for backtracking the camera positions or orientations of captured images using motion information of the images captured in two dimensions and then structuring the relationships between the images and the cameras. When the SfM algorithm is utilized, it is possible to acquire the locations of cameras or internal and external parameters of the cameras by obtaining unique feature points of each image, matching feature points with each captured scene, and calculating the relationships therebetween.

As described above, the server 100 may acquire an object mask and camera information corresponding to each of the plurality of images through preprocessing of the image.

In addition, the server 100 may acquire a plurality of background images corresponding to each of the images on the basis of the object mask and acquire depth information on the basis of camera information corresponding to each of the plurality of acquired background images. According to the exemplary embodiment, depth information of each background image may be acquired using a deep learning-based multi-view stereo (MVS) method.

In addition, the server 100 may project each image to a 3D space on the basis of camera information and depth information corresponding to the image and acquire a cube map on the basis of pixel values of the background images projected to the 3D space.

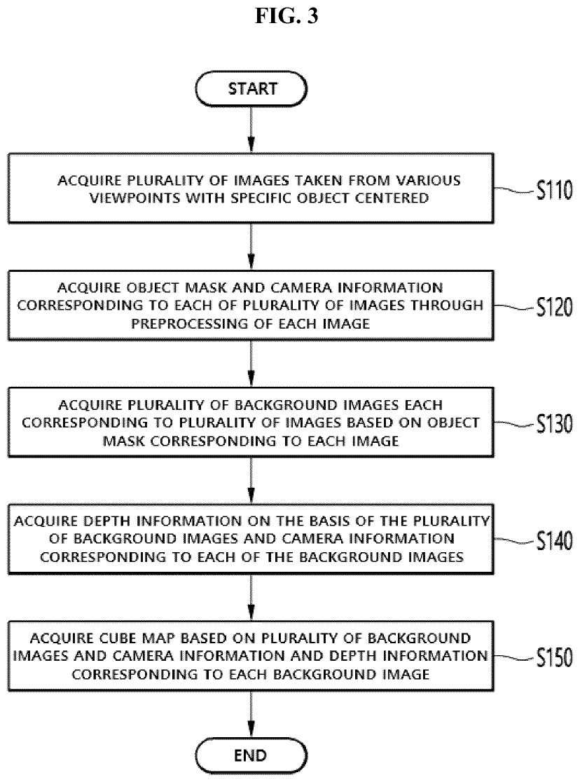

In other words, according to the present invention, a cube map is generated on the basis of a plurality of images taken with a specific object centered that are related to multiple viewpoints by utilizing a general camera (e.g., a single lens) rather than previously stitched images or images acquired through a camera equipped with specialized hardware such as a specialized lens (e.g., a fisheye lens) or two or more lenses. Since neither a camera equipped with specialized hardware nor stitched images are utilized, this can improve the ease of generating a cube map for a user without additional hardware or expert knowledge. Further details of the method of generating a cube map on the basis of a plurality of images related to multiple viewpoints according to the present invention will be described below with reference to FIG. 3.

According to the embodiment, only the single server 100 is shown in FIG. 1, but it is apparent to those of ordinary skill in the art that more servers may be included within the scope of the present invention and the server 100 may include additional components. That is, the server 100 may be composed of a plurality of computing devices. In other words, a set of a plurality of nodes may constitute the server 100.

According to the embodiment of the present invention, the server 100 may be a server that provides a cloud computing service. More specifically, the server 100 may be a server that provides, as a type of Internet-based computing, a cloud computing service of processing information using another computer connected to the Internet rather than the user's computer. The cloud computing service may be a service for storing data on the Internet and making data or programs available to a user anytime and anywhere through Internet access without requiring the user to install necessary the data or programs on his or her own computer, and may facilitate sharing and transmitting data stored on the Internet with simple operations and clicks. Also, the cloud computing service may be a service that is not only for storing data on a server on the Internet but also for performing desired tasks using the functions of application programs provided on the Web without installing programs and enables several people to simultaneously share documents and work together. In addition, the cloud computing service may be implemented in the form of at least one of an infrastructure as a service (IaaS), a platform as a service (PaaS), software as a service (Saas), a virtual machine-based cloud server, and a container-based cloud server. In other words, the server 100 of the present invention may be implemented in the form of at least one of the foregoing cloud computing services. The foregoing specific cloud computing services are merely illustrative, and any platform for constructing a cloud computing environment of the present invention may be included.

The user terminal 200 according to the embodiment of the present invention may be any form of node(s) in a system having mechanisms for communication with the server 100. The user terminal 200 is a terminal that may receive a cube map generated in accordance with a plurality of images by exchanging information with the server 100, and may be a terminal owned by a user. In addition, according to the embodiment, the user terminal 200 may be a terminal that acquires a plurality of images related to multiple viewpoints. For example, the user terminal 200 may include an image module (e.g., a camera) for acquiring images and utilize the image module to take and acquire a plurality of images related to various viewpoints with a specific object centered. According to the embodiment, the camera module provided in the user terminal 200 may be a general camera module provided with a single lens. In other words, a plurality of images utilized in the present invention may be 360° images (or panoramic images) acquired through a camera module including a specialized lens (e.g., a fisheye lens) or images acquired through a general camera module rather than images having undergone a stitching task.

According to the embodiment, the plurality of images acquired through the user terminal 200 may be transmitted to the server 100, and the server 100 may generate a cube map corresponding to the plurality of images and provide the cube map to the user terminal 200.

In other words, cube maps can be more easily generated from images acquired through a general camera module rather than from images acquired using specialized hardware (e.g., panoramic images) or from a plurality of images acquired through a multi-view camera that have undergone a stitching task.

According to various embodiments, the user terminal 200 may be a terminal that can acquire a plurality of images related to multiple viewpoints. For example, the user terminal 200 may have an image module (e.g., a camera) for acquiring images and utilize the image module to take and acquire a plurality of images related to various viewpoints with a specific object centered.

According to the embodiment, when multi-view images are received from the user terminal 200, the server 100 may recognize an object-of-interest region in the multi-view images and provide various services. For example, the server 100 may recognize the object-of-interest region in the multi-view images and reconstruct the object-of-interest region in three dimensions.

The user terminal 200 may refer to any form of entity(s) in a system having mechanisms for communication with the server 100. For example, the user terminal 200 may include a personal computer (PC), a notebook, a mobile terminal, a smartphone, a tablet PC, and a wearable device and include any type of terminal that can access a wired/wireless network. Also, the user terminal 200 may include any server implemented using at least one of an agent, an application programming interface (API), and a plug-in. In addition, the user terminal 200 may include an application source and/or a client application.

According to the embodiment, the external server 300 may be connected to the server 100 through the network 400 and receive, store, and manage result data that is derived by the server 100 performing the method of generating a cube map from a plurality of images related to multiple viewpoints or providing various information/data required for performing the method of generating a cube map from a plurality of images. For example, the external server 300 may be a storage server separately provided outside of the server 100 but is not limited thereto.

According to the embodiment, information stored in the external server 300 may be utilized as training data, validation data, and test data for training an artificial neural network of the present invention. In other words, the external server 300 may store data for training the artificial neural network of the present invention. The server 100 of the present invention may build a plurality of training datasets on the basis of information received from the external server 300. The server 100 may generate a plurality of artificial neural models by training one or more network functions using each of the plurality of training datasets.

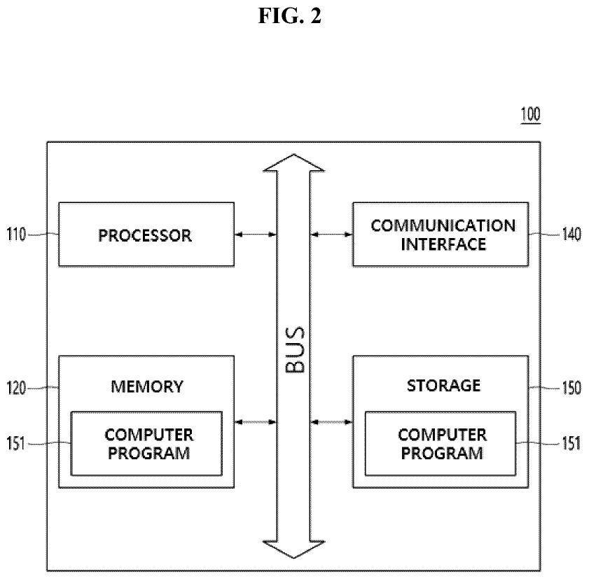

The external server 300 may be a digital device that has a processor, a memory, and a computing capability, such as a laptop computer, a notebook computer, a desktop computer, a web pad, or a mobile phone. The external server 300 may be a web server that processes a service. The foregoing types of servers are merely illustrative, and the present disclosure is not limited thereto. A hardware configuration of the server 100 that performs the method of generating a cube map from a plurality of images will be described below with reference to FIG. 2.

FIG. 2 is a hardware configuration diagram of a server for performing the method of generating a cube map from a plurality of images according to an embodiment of the present invention.

Referring to FIG. 2, the server 100 that performs the method of generating a cube map from a plurality of images according to the embodiment of the present invention may include at least one processor 110, a memory 120 into which a computer program 151 executed by the processor 110 is loaded, a bus 130, a communication interface 140, and a storage 150 in which the computer program 151 is stored. FIG. 2 only shows components related to the embodiment of the present invention. Accordingly, those of ordinary skill in the technical field to which the present invention pertains should recognize that general purpose components may be included in addition to the components shown in FIG. 2.

According to the embodiment of the present invention, the processor 110 may generally process overall operations of the server 100. The processor 110 may process a signal, data, information, and the like input or output through the foregoing components or execute an application program stored in the memory 120, thereby providing appropriate information or a function to a user or a user terminal or processing the information or function.

In addition, the processor 110 may perform computation for at least one application or program for performing methods according to embodiments of the present invention, and the server 100 may include one or more processors.

According to the embodiment of the present invention, the processor 110 may be composed of at least one core and include a processor for data analysis and deep learning such as a central processing unit (CPU) of a computer device, a general-purpose graphics processing unit (GPGPU), a tensor processing unit (TPU), and the like.

The processor 110 may read a computer program stored in the memory 120 to provide the method of generating a cube map from a plurality of images according to the embodiment of the present invention.

According to various embodiments, the processor 110 may further include a random access memory (RAM) (not shown) and a read-only memory (ROM) that temporarily and/or permanently store signals (or data) processed in the processor 110. Also, the processor 110 may be implemented in the form of a system on chip (SoC) including at least one of a graphics processing unit, a RAM, and a ROM.

The memory 120 stores various data, instructions, and/or information. The computer program 151 may be loaded from the storage 150 into the memory 120 to perform methods/operations according to various embodiments of the present invention. When the computer program 151 is loaded into the memory 120, the processor 110 may execute one or more instructions constituting the computer program 151, thereby performing the methods/operations. The memory 120 may be implemented as a volatile memory such as a RAM, but the technical scope of the present disclosure is not limited thereto.

The bus 130 provides a communication function between components. The bus 130 may be implemented in various types of buses such as an address bus, a data bus, a control bus, and the like.

The communication interface 140 supports wired and wireless Internet communication of the server 100. Also, the communication interface 140 may support various communication methods other than Internet communication. To this end, the communication interface 140 may include a communication module well known in the technical field of the present invention. According to some embodiments, the communication interface 140 may be omitted.

The computer program 151 may be non-temporarily stored in the storage 150. When the server 100 performs a process for generating a cube map from a plurality of images, the storage 150 may store various information required for providing the process for generating a cube map from a plurality of images.

The storage 150 may include a non-volatile memory such as a ROM, an erasable programmable ROM (EPROM), an electrically erasable programmable ROM (EEPROM), a flash memory, and the like, a hard disk, a detachable disk, or any form of computer-readable recording medium well known in the technical field to which the present invention pertains.

The computer program 151 may include one or more instructions that cause the processor 110 to perform the methods/operations according to various embodiments of the present invention when loaded into the memory 120. In other words, the processor 110 may execute the one or more instructions, thereby performing the methods/operations according to various embodiments of the present invention.

According to the embodiment, the computer program 151 may include one or more instructions to perform the method of generating a cube map from a plurality of images including an operation of acquiring a plurality of images taken from various viewpoints with a specific object centered, an operation of acquiring an object mask and camera information corresponding to each of the plurality of images through preprocessing of the image, an operation of acquiring a plurality of background images each corresponding to the plurality of images on the basis of the object mask corresponding to each of the images, an operation of acquiring depth information on the basis of the plurality of background images and camera information corresponding to each of the images, and an operation of acquiring a cube map on the basis of the plurality of background images and the camera information and the depth information corresponding to each of the background images.

According to another embodiment, the computer program 151 may include one or more instructions to perform a method of recognizing an object of interest on the basis of multi-view images including an operation of acquiring multi-view images including a plurality of images related to various viewpoints, an operation of extracting an object-of-interest region from the multi-view images, an operation of correcting the extracted object-of-interest region, an operation of selecting reference images among the multi-view images, an operation of generating a cost volume on the basis of the reference image, and an operation of setting a final object-of-interest region on the basis of the cost volume.

Operations of the methods or algorithms described in relation to embodiments of the present invention may be directly implemented by hardware, implemented as software modules executed by hardware, or implemented in a combination thereof. The software modules may reside in a RAM, a ROM, an EPROM, an EEPROM, a flash memory, a hard disk, a detachable disk, a compact disc (CD)-ROM, or any form of computer-readable recording medium well known in the technical field to which the present invention pertains.

Components of the present invention may be implemented as a program (or an application) and stored in a medium for execution in combination with a computer which is hardware. Components of the present invention may be executed by software programming or as software elements. Similarly, an embodiment may be implemented using a programming or scripting language, such as C, C++, Java, an assembler, or the like, with various algorithms being implemented in a combination of data structures, processes, routines, or other programming elements. Functional aspects may be implemented using an algorithm executed by one or more processors. The method of generating a cube map from a plurality of images which is performed by the server 100 will be described in detail below with reference to FIGS. 3 to 7.

FIG. 3 is a flowchart illustrating a method of generating a cube map from a plurality of images according to the embodiment of the present invention. Operations shown in FIG. 3 may be reordered as necessary, and at least one operation may be omitted or added. In other words, the following operations merely correspond to an embodiment of the present invention, and the scope of the present invention is not limited thereto.

According to the embodiment of the present invention, the method of generating a cube map from a plurality of images may include an operation S110 of acquiring a plurality of images taken from various viewpoints with a specific object centered. According to the embodiment, acquiring the plurality of images may include receiving data stored in the memory 120 or loading data into the memory 120. Acquiring the plurality of images may include receiving a plurality of pieces of training data from another computing device or a separate processing module in the same computing device or loading a plurality of pieces of training data to another storage medium on the basis of a wired/wireless means of communication. For example, the plurality of images may be received from a user terminal.

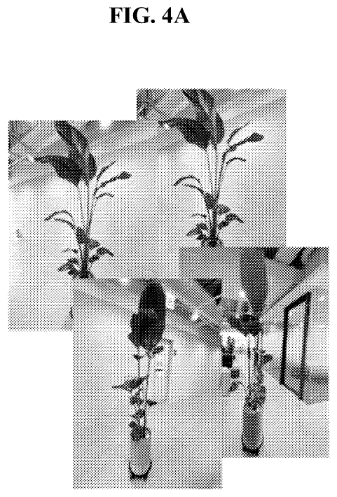

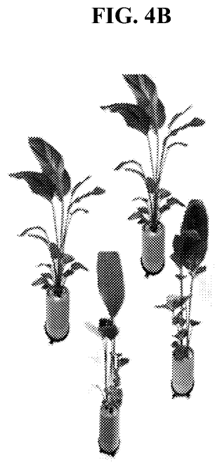

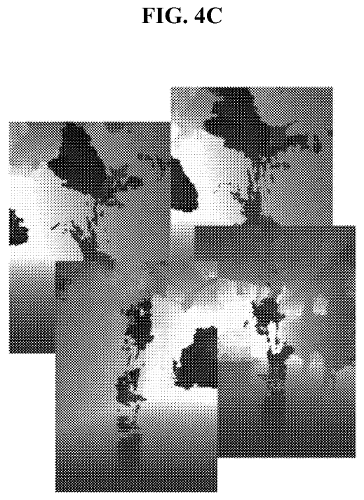

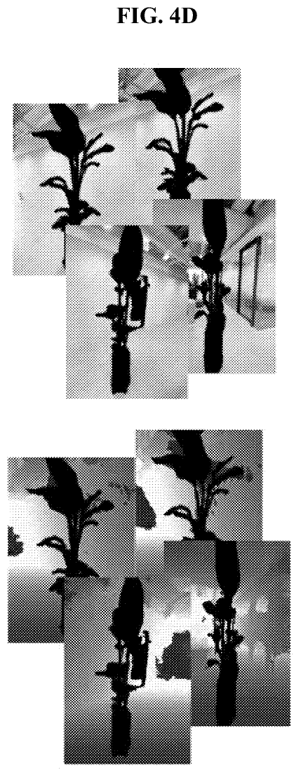

The plurality of images may include multi-view images acquired by utilizing cameras provided with a single lens. Each of the images may include the specific object and may be an image taken to at least partially overlap adjacent images related to adjacent viewpoints. In other words, according to the present invention, a plurality of images on which to base cube map generation may be images taken with a specific object centered, and the images may overlap each other. The plurality of images may be acquired through a user terminal. For example, the user terminal 200 may have a camera module, and the plurality of images may be acquired through the camera module and transmitted to the server 100. As a specific example, the user may acquire a plurality of images based on a specific object (e.g., a vase) from various viewpoints through the user terminal 200 as shown in FIG. 4A. The plurality of images acquired through the user terminal 200 may include images taken from various viewpoints centered on the specific object (e.g., the vase).

According to the embodiment, the server 100 may determine appropriateness related to cube map generation on the basis of whether the specific object is in each of the plurality of images and whether there are overlap regions between the plurality of images. Here, determining the appropriateness may include determining whether the plurality of acquired images are appropriate for generating a cube map.

Specifically, the operation of acquiring a plurality of images may include an operation of acquiring images taken in accordance with movement of a user terminal, an operation of identifying whether the specific object is in each image, and an operation of removing images without the specific object. When the plurality of images are acquired from the user terminal 200, the server 100 may determine whether the specific object is included in each image. According to the present invention, a cube map is generated on the basis of surrounding background images of a specific object, and thus the centered specific object should be included in each image. For example, when an image not including the specific object is utilized, the accuracy of cube map generation may be degraded. Accordingly, the server 100 may determine images not including the specific object as images inappropriate for generating a cube map. The server 100 may exclude the images determined to be inappropriate for generating a cube map. In other words, the server 100 may only select images including the specific object centered therein during the cube map generation process and utilize the selected images for generating a cube map.

In addition, the operation of acquiring a plurality of images may include an operation of acquiring images taken in accordance with movement of a user terminal, an operation of identifying whether there is an overlap region between adjacent images, an operation of determining whether the overlap region has a size of a preset threshold or more when there is an overlap region between the adjacent images, and an operation of transmitting a direction for acquiring an additional image to the user terminal when the size of the overlap region is smaller than the threshold.

According to the embodiment, the plurality of images are images to be utilized for generating a cube map and thus should be taken such that at least some of the images have overlap regions. For example, in the case of adjacent images that have no overlap region therebetween or images having a remarkably small overlap region therebetween (i.e., images having an overlap region with a size smaller than the preset threshold), it is difficult to calculate camera information. Accordingly, those images may be inappropriate for generating a cube map. According to the embodiment, a size of an overlap region related to the preset threshold may be related to the existence of a region overlapping 70% or more of an adjacent image. For example, when an overlap region between adjacent images is 70% or more, a size of the overlap region may be greater than the preset threshold or more. Accordingly, when adjacent images are identified to have an overlap region with a size smaller than the preset threshold, the server 100 may generate a direction for acquiring an additional image and transmit the direction to the user terminal. In this case, the direction for acquiring an additional image may include information directing the user to move at various angles, left, right, up, down, and the like, from a specific image and take images. For example, when an overlap region between a first image and a second image adjacent to the first image have a size smaller than the preset threshold, the server 100 may generate a direction that enables the user to take an image at an angle from the first image such that the image overlaps a certain ratio or more of the first image. The user may acquire additional images through additional imaging based on a direction displayed on the user terminal 200 and transmit the additional images to the server 100.

In other words, the server 100 may determine whether additional images (e.g., images having an overlap region corresponding to a certain ratio or more) are required for generating a cube map on the basis of overlap regions between adjacent images, and when it is determined that additional images are required, may generate a direction for acquiring additional images. The user may easily take additional images and transmit the additional images to the server 100 by following the direction displayed on his or her terminal, and the server 100 may utilize the supplemental images to generate a cube map.

According to the embodiment of the present invention, the method of generating a cube map from a plurality of images may include an operation S120 of acquiring an object mask and camera information corresponding to each of the plurality of images through preprocessing of the image.

According to the embodiment, preprocessing the plurality of images may include preprocessing for acquiring an object mask related to the specific object included in each image and preprocessing for acquiring camera information corresponding to each image.

Specifically, the server 100 may acquire an object mask related to the specific mask from each image by utilizing a deep learning-based algorithm. The deep learning-based algorithm may be a neural network model (e.g., a CNN model) trained to acquire an object mask related to a specific object from an image. For example, the deep learning-based algorithm may consider similar pixels as one unit on the basis of a feature representing one region and acquire an object mask related to a specific object in an image using a region-based segmentation method of segmenting regions with the same characteristic, an edge-based segmentation method of extracting an edge from an image and then extracting significant regions using the obtained edge information, and the like.

According to the embodiment, the server 100 may acquire camera information corresponding to each image by utilizing an SfM algorithm.

The SfM algorithm may be an algorithm for backtracking the camera positions or orientations of captured images using motion information of the images captured in two dimensions and then structuring the relationships between the images and the cameras. When the SfM algorithm is utilized, it is possible to acquire the locations of cameras by obtaining unique feature points of each image, matching feature points with each captured scene, and calculating the relationships therebetween.

Specifically, the operation of acquiring an object mask and camera information corresponding to each of the plurality of images through preprocessing of the image may include an operation of extracting feature points from each of the plurality of images, an operation of matching the extracted feature points with an adjacent image, an operation of acquiring initial camera information corresponding to each image on the basis of matching points, and an operation of acquiring camera information corresponding to each image by optimizing the initial camera information.

More specifically, the server 100 may extract feature points from each image and match the extracted feature points with an adjacent image. When feature points of each image match feature points of an adjacent image, initial camera information corresponding to all the images may be calculated. Here, the initial camera information may include information on camera poses and camera parameters (internal parameters and external parameters). Also, the server 100 may optimize the initial camera information through bundle adjustment, thereby acquiring camera information. In this case, bundle adjustment may represent an algorithm for simultaneously optimizing a 3D position that may be estimated on the basis of feature points, and a three-dimensionally linked motion among images. In other words, the server 100 may acquire camera information through the process of matching feature points of the images with each other to calculate initial camera information and optimizing the initial camera information.

According to the embodiment of the present invention, the method of generating a cube map from a plurality of images may include an operation S130 of acquiring a plurality of background images each corresponding to the plurality of images on the basis of the object mask corresponding to each of the images.

According to the embodiment of the present invention, a reflection characteristic is approximated from surroundings of a specific object, and thus a background image excluding the specific object is necessary. To this end, an object mask may be calculated from an image, and a background image may be extracted by utilizing a mask image corresponding to the object mask. As a specific example, referring to FIGS. 4A and 4B, mask images may be extracted using object masks of a specific object. In this case, with the extraction of the mask images, background images for each of viewpoints are acquired.

According to the embodiment of the present invention, the method of generating a cube map from a plurality of images may include an operation S140 of acquiring depth information on the basis of the plurality of background images and camera information corresponding to each of the background images.

According to the embodiment, information about how far the object in the real world is from the camera module pixel by pixel may be required for projecting a two-dimensional (2D) image to three dimensions. To this end, the server 100 may acquire depth information on the basis of camera information corresponding to each image.

More specifically, in the operation of acquiring depth information on the basis of the plurality of background images and the camera information corresponding to each of the background images, an MVS algorithm may be utilized to extract depth information corresponding to each background image. The MVS algorithm is an algorithm for acquiring precise depth information by utilizing camera position information on the basis of a plurality of images acquired at any view angle from several viewpoints. According to a specific embodiment of the present invention, a UniMVSNet algorithm among MVS algorithms may be utilized to predict depth information corresponding to each viewpoint-specific image.

In other words, the server 100 may acquire accurate depth information corresponding to each viewpoint-specific image using a deep learning-based MVS algorithm. FIG. 4C is a set of views illustrating distance (i.e., depth) between cameras and objects using color density. As shown in FIG. 4C, depth information may be acquired in accordance with the viewpoint-specific images. With the acquisition of the depth information, pixel points of each image can be projected to a 3D space.

According to the embodiment of the present invention, depth information corresponding to viewpoint-specific background images is acquired in accordance with the background images from which the specific object has been removed using the object masks. In the present invention, a plurality of images are taken on the basis of a specific object to identify the relationships between the images, but the specific object should be excluded from a generated cube map. Accordingly, the server 100 may acquire background images by removing the specific object from each of the images using the object masks and acquire depth information corresponding to each of the acquired background images. In other words, as shown in FIG. 4D, depth information may be acquired in accordance with each of the viewpoint-specific background images.

According to the embodiment of the present invention, the method of generating a cube map from a plurality of images may include an operation S150 of acquiring a cube map on the basis of the plurality of background images and camera information and depth information corresponding to each of the background images. In the present invention, a cube map may be texture in which surroundings of a viewpoint may be rendered and stored in advance. For example, a cube map may be texture including screen data that expresses scenes around an object as if the object were at the center of a cube. Such a cube map may be utilized during the process of rendering a 3D space efficiently and realistically.

According to the embodiment, the operation of acquiring a cube map may include an operation of projecting the plurality of background images to the 3D space on the basis of camera information and depth information corresponding to each of the background images. Specifically, the server 100 may reproject the background images as 3D point clouds using the camera information and depth information corresponding to each of the background images. A point in a 3D space may be calculated as shown in the following equation.

$$[ \begin{matrix}X \\ Y \\ Z\end{matrix} ] = {[ R \vert t ]}^{- 1} {K}^{- 1} [ \begin{matrix}d * u \\ d * v \\ d\end{matrix} ]$$

In the above equation, d is a depth value, u and v are pixel coordinates, k is an internal camera parameter, and [R|t]⁻¹ is an external camera parameter (rotation R and translation t). After an image coordinate system is converted into a camera coordinate system by calculating a matrix product of an inverse matrix of the internal camera parameter and pixel coordinates including the depth value, the camera coordinate system may be converted into a world coordinate system by calculating a matrix product of the calculated matrix product and an inverse matrix of the external camera parameter. In other words, each background image may be projected to the 3D space by utilizing the above equation.

In addition, the operation of acquiring a cube map may include an operation of acquiring a cube map on the basis of the plurality of background images projected to the 3D space.

More specifically, the operation of acquiring a cube map on the basis of the plurality of background images projected to the 3D space may include an operation of converting coordinates corresponding to each point in the 3D space into spherical coordinates corresponding to a spherical coordinate system. The server 100 may convert points reprojected to the 3D space into the spherical coordinate system to present the reprojected points as points in a spherical space. 3D Cartesian coordinates are converted into spherical coordinates using the following equations.

$$\begin{matrix}r = \sqrt{{X}^{2} + {Y}^{2} + {Z}^{2}} \\ θ = arccos ( \frac{Z}{r} ) \\ ϕ = arccos ( \frac{Y}{X} )\end{matrix}$$

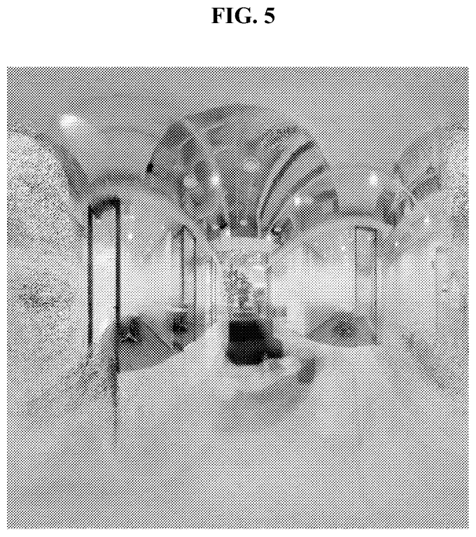

In addition, the operation of acquiring a cube map on the basis of the plurality of background images projected to the 3D space may include an operation of generating a cube map on the basis of spherical coordinates of each point and a pixel value corresponding to the point. The server 100 converts the points reprojected to the 3D space into spherical coordinates. In this case, the server 100 may map spherical coordinates of each point and a pixel value corresponding to the point to a cube map image, and a result image of mapping, that is, a cube map, is shown in FIG. 5.

According to various embodiments, the server 100 may inpaint a vacant space of the generated cube map. For example, the finally generated cube map may include a vacant space that has not been observed. Accordingly, the server 100 may correct the cube map.

Specifically, the method of generating a cube map from a plurality of images may further include an operation of correcting the cube map. Here, the operation of correcting the cube map may include an operation of identifying a missing region in the cube map. For example, the missing region (or vacant space) may be a region corresponding to a part that is not identified from the plurality of images. The server 100 may identify a missing region corresponding to a vacant space of the cube map that has not been observed.

In addition, the operation of correcting the cube map may include an operation of calculating missing pixel values on the basis of adjacent pixel values of the missing region and making up for the missing region on the basis of the missing pixel values. In other words, the server 100 may calculate missing pixel values to be similar to adjacent pixel values and make up for the mission region on the basis of the missing pixel values, thereby generating a natural-looking cube map.

In other words, when a vacant space (i.e., a missing region) is identified in a cube map, the server 100 may calculate values for the vacant space by interpolating using adjacent pixels of the vacant space and make up for the corresponding region on the basis of the values. This makes up for a part that has not been observed, making it possible to generate and provide a natural-looking cube map.

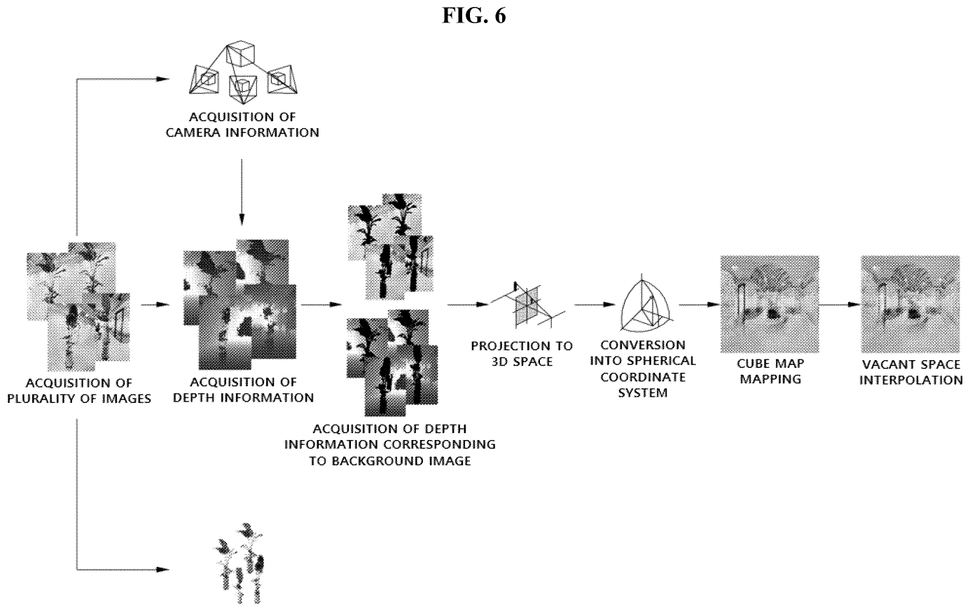

To summarize the overall process of the present invention with reference to FIG. 6, the server 100 may preprocess a plurality of acquired images to obtain an object mask and camera information corresponding to each image. Also, the server 100 may acquire depth information corresponding to each image on the basis of camera information corresponding to the image by utilizing an MVS algorithm.

According to a more specific embodiment, the server 100 may extract an object mask corresponding to each image to acquire a background image corresponding to the image and may acquire depth information corresponding to each background image on the basis of camera information of the background image. Accordingly, it is possible to acquire images (e.g. background images) from which a specific object has been removed and depth information corresponding to the images.

The server 100 may generate a cube map using these background images and depth information and camera information corresponding to each of the background images. Specifically, the server 100 may reproject 2D images to a 3D space using depth information and camera information of each background image. Also, the server 100 may convert coordinates of 3D space points into spherical coordinates, thereby presenting the 3D space points as points in a spherical space. Accordingly, the server 100 may generate a cube map image using spherical coordinates and pixel values of points.

In addition, the server 100 may correct a vacant space of the generated cube map that has not been observed. Specifically, the server 100 may identify the vacant space in the cube map, calculate values for the vacant space by interpolating using adjacent pixels of the corresponding space, and make up for the corresponding region on the basis of the calculated values. In other words, the server 100 can generate and provide a natural-looking cube map through inpainting of a vacant space.

Therefore, according to the present invention, it is possible to generate and provide a cube map on the basis of images acquired through a general camera without specialized hardware equipment (e.g., a specialized lens) for acquiring a panoramic image on which to base cube map generation or without any stitching task for acquired images. This enables a user to render an actual environment more realistically and provides the effect of further advancing a 3D transformation module in which a reflection characteristic is taken into consideration.

Meanwhile, to recognize a specific object (or an object of interest) in multi-view images related to multiple viewpoints, the position of the object should be consistent between the viewpoints. However, a conventional method of recognizing an object of interest in a video or an image is not based on multi-view images related to multiple viewpoints and thus cannot maintain prediction consistency for the same point.

The server 100 of the present invention recognizes an object of interest on the basis of multi-view images related to multiple viewpoints. Specifically, the server 100 may estimate an object-of-interest region in multi-view images including a plurality of images related to various viewpoints. Here, an object-of-interest region relates to at least one of objects included in an image and may be a region in which an object separable from, for example, the wall or floor is present. For example, objects of interest may be a desk, a chair, a cup, a vacuum, and the like included in an image. The foregoing details of objects of interest are merely illustrative, and the present invention is not limited thereto. The server 100 may utilize an object recognition model to identify an object-of-interest region in multi-view images. The object recognition model may be a deep learning model that recognizes an object of interest on the basis of an image.

In addition, the server 100 may correct the estimated object-of-interest region in accordance with the multi-view images. When the estimated object-of-interest region is corrected, the recognition accuracy of a finally predicted object-of-interest region may be improved.

According to the embodiment, an output of the object recognition model, that is, the object-of-interest region in the multi-view images, may have an approximate shape. Accordingly, the server 100 may perform correction by utilizing a deep learning network to show the object-of-interest region in further detail. The server 100 may process the output of the object recognition model as an input for a correction network function, thereby outputting a corrected object-of-interest region corresponding to the object-of-interest region. For example, a network structure utilized in a deep learning network for correction is generally a structure in which, when an approximate mask is used as an input, the input is processed through a convolutional network and subjected to a normalization process employing a sigmoid function such that a more minute mask is output. However, the sigmoid function is a function having a value of 0 to 1, and thus precise correction may be difficult. For example, the normalization process employing the sigmoid function may reduce previously imprecise masks, but cannot generate (or reconstruct) a region that has been poorly observed. Therefore, according to the present invention, an output layer of the object recognition model employs a tanh function, which allows more precise correction. The tanh function has a value of −1 to 1, and thus not only reduces parts that are imprecise but also performs correction such that parts which have not been predicted by a previous network may be shown.

In addition, the server 100 may select reference images among multi-view images to generate a cost volume. Here, the reference images may be images corresponding to viewpoints that will be referenced for a frame (or viewpoint) to be predicted. The server 100 may acquire depth information and camera information corresponding to each of the plurality of images included in the multi-view images and select a reference image on the basis of the depth information and the camera information. Here, the depth information may include information related to distances from cameras to objects included in each of the images, and the camera information may include camera pose information or information on camera parameters. According to the embodiment, camera parameter information may include internal camera parameter information and external camera parameter information. The internal camera parameter information may include information related to a focal length, a main point, and an asymmetry factor. The external camera parameter information is parameters for describing the conversion relationship between a camera coordinate system and a world coordinate system, which may be expressed as rotation and shift transformation between the two coordinate systems. The server 100 may warp the reference images on the basis of the depth information and the camera information to convert the reference images for a prediction viewpoint. In other words, the server 100 may warp reference images that will be referenced for a viewpoint to be predicted, using the prediction viewpoint, thereby generating warped images. Also, the server 100 may stack the warped images to generate a cost volume. In other words, the server 100 may convert reference images related to adjacent viewpoints using the depth information and the camera information (e.g., the external camera parameter information) on the basis of a prediction viewpoint and stack the converted images to generate a cost volume. Since the cost volume is a set of images that have been converted on the basis of the same viewpoint, it is possible to detect as many identical points as possible by utilizing the cost volume.

In addition, the server 100 may set a final object-of-interest region on the basis of the cost volume generated in accordance with the multi-view images. In other words, when a cost volume is generated by stacking images converted (or warped) on the basis of the same prediction viewpoint and an object-of-interest region is set on the basis of the generated cost volume, consistent object recognition is possible in various viewpoint images. This provides a consistent prediction result in accordance with multi-view images related to multiple viewpoints.

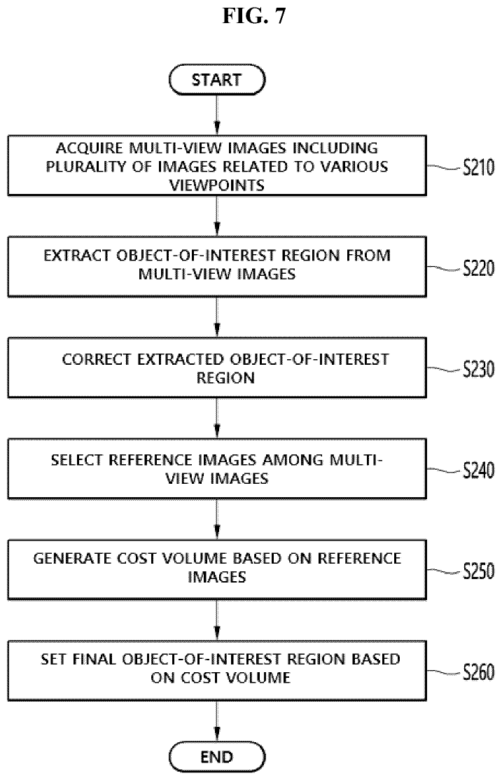

FIG. 7 is a flowchart illustrating a method of recognizing an object of interest on the basis of multi-view images according to an embodiment of the present invention. Operations shown in FIG. 7 may be reordered as necessary, and at least one operation may be omitted or added. In other words, the following operations merely correspond to an embodiment of the present invention, and the scope of the present invention is not limited thereto.

According to the embodiment of the present invention, the method of recognizing an object of interest on the basis of multi-view images may include an operation S210 of acquiring multi-view images including a plurality of images related to various viewpoints.

According to the embodiment, acquiring multi-view images may include receiving data stored in the memory or loading data into the memory 120. Acquiring multi-view images may include receiving a plurality of pieces of training data from another computing device or a separate processing module in the same computing device or loading a plurality of pieces of training data to another storage medium on the basis of a wired/wireless means of communication. For example, the plurality of images may be received from a user terminal.

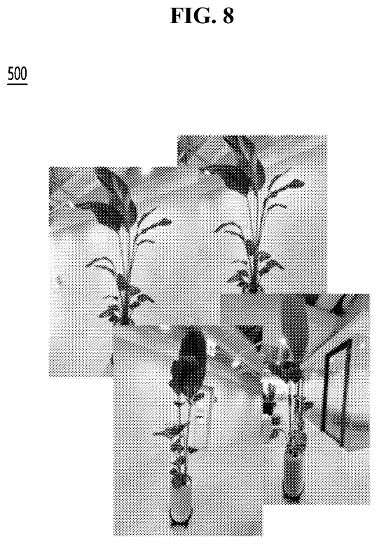

Multi-view images of the present invention may include a plurality of images acquired from various viewpoints. For example, multi-view images of the present invention may include images taken at various angles on the basis of a specific object. The multi-view images may include images related to multiple viewpoints that are acquired through a camera module. According to various embodiments, each of the plurality of images included in the multi-view images may include the specific object and may be images taken to at least partially overlap adjacent images related to adjacent viewpoints. The plurality of images may be images taken with the specific object centered, and may have overlap regions therebetween. As a specific example, as shown in FIG. 8, multi-view images 500 may include a plurality of images acquired from various viewpoints on the basis of a specific object (e.g., a vase).

According to the embodiment of the present invention, the method of recognizing an object of interest on the basis of multi-view images may include an operation S220 of extracting an object-of-interest region from the multi-view images.

Specifically, the operation of extracting an object-of-interest region may include an operation of identifying an object-of-interest region corresponding to each of the plurality of images by utilizing an object recognition model.

According to the embodiment, the object recognition model may be a deep learning model that recognizes an object of interest on the basis of a single viewpoint image. According to a specific embodiment, the object recognition model may be a U²-Net. The U²-Net may be a model of a U-shaped encoder-decoder architecture layered on top of a conventional deep learning architecture. For example, the U²-Net may include 6 encoders, 5 decoders, a sigmoid function, and a convolutional layer. The U²-Net may be generated by sequentially connecting the plurality of encoders and the plurality of decoders in the U-shaped structure. Since the network becomes deeper with the U-shaped architecture, it is possible to acquire a high-resolution image. In other words, the overlapping U-shaped architecture can help the object recognition model learn global features.

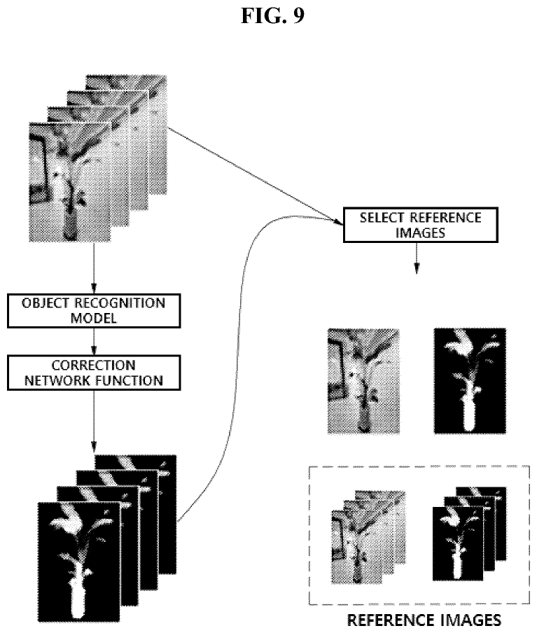

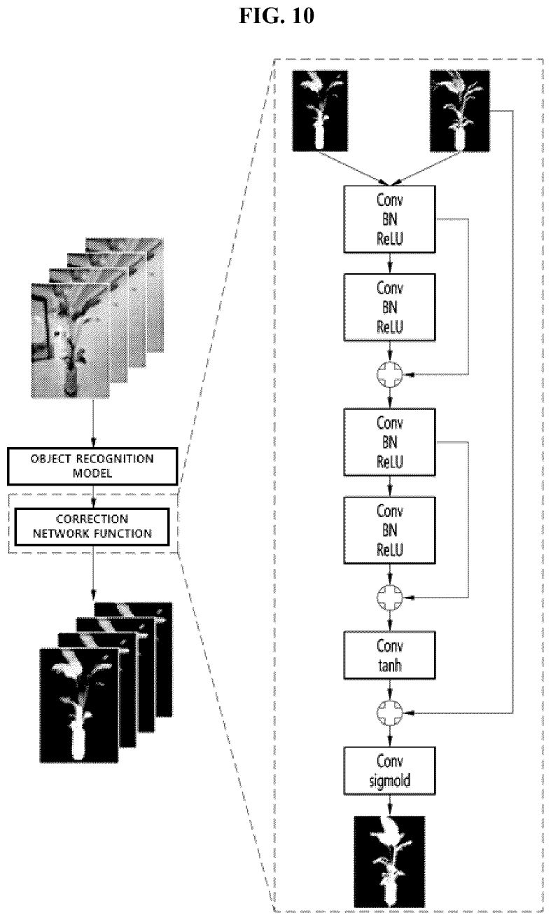

The server 100 may process each of the plurality of images included in the multi-view image as an input for the object recognition model, thereby identifying an object-of-interest region corresponding to the image. As a specific example, as shown in FIG. 9, each of the plurality of images may be processed as an input for the object recognition model, and in this case, the object recognition model may recognize an object-of-interest region in response to each image. According to the embodiment, an object-of-interest region may appear white within an image space having the same size as an input image as shown in FIGS. 9 and 10.

According to the embodiment of the present invention, the method of recognizing an object of interest on the basis of multi-view images may include an operation S230 of correcting the extracted object-of-interest region.

According to the embodiment, an output of the object recognition model, that is, the object-of-interest region in the multi-view images, may have an approximate shape. Accordingly, the server 100 may perform correction by utilizing a deep learning network to show the object-of-interest region in further detail.

Specifically, the operation of performing correction may include an operation of processing the output of the object recognition model as an input for the correction network function to output a corrected object-of-interest region corresponding to the object-of-interest region. Referring to FIG. 9, the output (e.g., an object-of-interest region extracted from each image) of the object recognition model may be input to the correction network function.

According to the embodiment, the correction network function may correct an image using an object-of-interest region corresponding to an image related to a previous input as a guide. The correction network function may enable the object recognition model to better predict frames along a continuous video flow.

In general, according to network structures for correction used in most deep learning networks, when an approximate prediction mask is input, the input is passed through a convolutional network, and a sigmoid function is applied to the result for a normalization process such that a more minute mask may be output. In this case, the normalization process is a task for making a previously imprecise mask precise, but precise correction may be difficult. As a specific example, the sigmoid function is a function having a value of 0 to 1 and thus can reduce previously imprecise masks, but cannot generate (or reconstruct) a region that has been poorly observed.

Accordingly, the present invention provides a correction network (i.e., a correction network function) that uses a mask of a frame related to a previous input as a guide.

More precise correction can be performed by configuring a correction network function of the present invention using a tanh function. The tanh function has a value of −1 to 1, and thus not only reduces parts that are imprecise but also performs correction such that parts which have not been predicted by a previous network may be shown.

In other words, the correction network function performs a convolution operation and then utilizes the tanh function rather than the sigmoid function to generate values of −1 to 1, thereby performing correction to not only remove incorrect parts but also show parts which have not been predicted by a previous network.

Ground-truth labels for training the correction network function may be presented as the following PyTorch-style pseudocode.
Algorithm 1. PyTorch-style pseudocode to generate correction label
#image_label: the ground-truth label of an image to be predicted (a binary mask composed of 0 and 1)
#prev_mask: the mask of a previous frame (a binary mask composed of 0 and 1)
#coarse_mask: an approximate prediction mask predicted through a U²-Net
#Compare the ground truth with the mask of the previous frame to reflect changes over the video flow. (set a variation to −1 to 1 because the position of an object changes with camera movement)->corr_area=torch.clamp ((image_label*2)-prev_mask, −1, 1)
#When the predicted mask is compared with the ground truth and the prediction is already correct, a variation is 0, and no correction is made.->corr_area=torch.where ((coarse_mask>0) & (image_label>0), torch.zeros_like (corr_area), corr_area)
#When an incorrect prediction determining a part that is not an object as an object is made, a variation of the part is set to −1 such that the part may be deleted.->corr_area=torch.where ((coarse_mask>0) & (image_label==0), torch.full_like (corr_area, −1), corr_area)

An output and loss function of the correction network function that is trained using labels generated by the above algorithm are shown below.

$$\begin{matrix}CorrNet ( {mask}_{prev} , {U}^{2} - net ( x ) ) = {y}_{final} , {y}_{diff} \\ {L}_{corr} = BCE ( {y}_{final} , {y}_{img} ) + {L}_{1} ( {y}_{diff} , {y}_{corr} )\end{matrix}$$

This network structure may be as shown in FIG. 10. In other words, the correction network function may perform correction on the basis of a mask of a previous frame, which allows more precise correction. In particular, when an output layer employs the tanh function, it is possible to perform correction not only to delete a specific part but also to fill in an unobserved part. This can provide a more minute representation of an object-of-interest region.

In other words, it may become possible to estimate a more minute object-of-interest region in a frame. This correction process may reduce errors that are caused during a warping process that follows.

According to the embodiment of the present invention, the method of recognizing an object of interest on the basis of multi-view images may include an operation S240 of selecting reference images among the multi-view images. The reference images may be images related to viewpoints that will be referenced for a frame to be predicted.

According to the embodiment, the server 100 may select reference images among the multi-view images on the basis of whether there is depth information and camera information corresponding to the multi-view images. When there is depth information and camera information corresponding to the multi-view images, the server 100 may select reference images using the corresponding depth information and camera information. According to the embodiment, when the depth information and camera information corresponding to the multi-view images do not exist, the server 100 may utilize a deep learning model to acquire the depth information and camera information corresponding to the multi-view images. The server 100 may process each image as an input for the deep learning model to acquire depth information and camera information corresponding to the image. According to a specific embodiment, depth information and camera information corresponding to each of the plurality of images may be acquired by utilizing COLMAP which is an SfM library.

According to the embodiment, the operation of selecting reference images among multi-view images may include an operation of acquiring depth information and camera information corresponding to the multi-view images.

According to various embodiments, the operation of acquiring camera information may include an operation of extracting feature points from each of the plurality of images, an operation of matching the extracted feature points with an adjacent image, an operation of acquiring initial camera information corresponding to each image on the basis of matching points, and an operation of acquiring camera information corresponding to each image by optimizing the initial camera information.

More specifically, the server 100 may extract feature points from each image and match the extracted feature points with an adjacent image. When feature points of each image are matched with feature points of an adjacent image, initial camera information corresponding to all the images may be calculated. Here, the initial camera information may include information on camera poses and camera parameters (internal parameters and external parameters). Also, the server 100 may optimize the initial camera information through bundle adjustment, thereby acquiring camera information. In this case, bundle adjustment may represent an algorithm for simultaneously optimizing a 3D position that may be estimated on the basis of feature points, and a three-dimensionally linked motion among images. In other words, the server 100 may acquire camera information through the process of matching feature points of the images with each other to calculate initial camera information and optimizing the initial camera information.

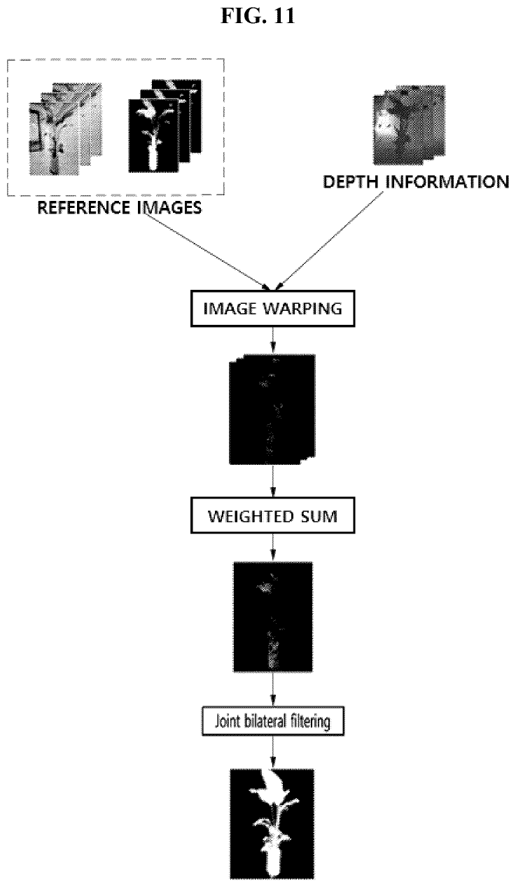

According to various embodiments, the operation of acquiring depth information may include an operation of extracting depth information corresponding to each image by utilizing an MVS algorithm. Here, the depth information may include information related to distances from cameras to objects included in each of the images. The server 100 may extract depth information corresponding to each image by utilizing the MVS algorithm. The MVS algorithm is an algorithm for acquiring precise depth information by utilizing camera position information on the basis of a plurality of images acquired at any view angle from several viewpoints. According to a specific embodiment of the present invention, a UniMVSNet algorithm among MVS algorithms may be utilized to predict depth information corresponding to each viewpoint-specific image. In other words, the server 100 may acquire depth information corresponding to each viewpoint-specific image using a deep learning-based MVS algorithm. As shown in FIG. 11, depth information may be presented as, for example, a difference in color density based on distances (i.e., depths) between cameras and objects. The distance between each object and a camera can be predicted from the depth information.

In addition, the operation of selecting reference images among the multi-view images may include an operation of selecting reference images on the basis of the depth information and the camera information. According to the embodiment, camera parameter information may include internal camera parameter information and external camera parameter information. The internal camera parameter information may include information related to a focal length, a main point, and an asymmetry factor. The external camera parameter information is parameters for describing the conversion relationship between a camera coordinate system and a world coordinate system, which may be expressed as rotation and shift transformation between the two coordinate systems.

The server 100 may extract rotation and translation matrices from the external camera parameters and calculate a distance L1 between the matrices from each viewpoint. According to the embodiment, the server 100 may select a reference image on the basis of the distance L1. For example, images that minimize the distance L1 may be selected as reference images. In this case, the distance alone may lead to the selection of exact opposite viewpoints depending on the size of an object, and thus it may be important that two viewpoints look in the same direction. Accordingly, the server 100 gives a weight to the rotation matrix such that the influence of the rotation matrix increases. According to a specific embodiment, the server 100 may set weights of the rotation matrix and the translation matrix to 0.7 and 0.3, respectively. The foregoing specific values of weights for the matrices are merely illustrative, and the present invention is not limited thereto.

According to the embodiment of the present invention, the method of recognizing an object of interest on the basis of multi-view images may include an operation S250 of generating a cost volume on the basis of the reference images. Since the cost volume is a set of images that have been converted on the basis of the same viewpoint, it is possible to detect as many identical points as possible by utilizing the cost volume.

Specifically, the operation of generating a cost volume may include an operation of warping the reference images on the basis of the depth information and the camera information to convert the reference images for a prediction viewpoint and an operation of stacking the images converted for the prediction viewpoint to generate a cost volume.

More specifically, referring to FIG. 11, the server 100 may warp the reference images on the basis of the depth information and the camera information to convert the reference images for the prediction viewpoint. The server 100 may calculate a transformation matrix (homography) from an adjacent viewpoint to the prediction viewpoint using depth information and an external camera parameter of each image. The transformation matrix may be calculated as follows.

$$Homography = {{k}_{0} [ {R}_{0} \vert {t}_{0} ] [ {R}_{i} \vert {t}_{i} ]}^{- 1} {k}_{i}^{- 1}$$

The adjacent viewpoint may be warped by applying the transformation matrix calculated using the equation and thus may be converted into the prediction viewpoint. In this case, an image of the adjacent viewpoint seen from the warped viewpoint may be generated.

According to various embodiments, the server 100 may only select highly reliable information from the depth information. For example, the reference images may be warped by only utilizing depth information with a certain level of reliability or higher such that the reference images may be converted for the prediction viewpoint. In this case, since only highly reliable information is selected, only accurate warped points are utilized, which minimizes errors.

That is, the server 100 may generate warped images by warping the reference images that will be referenced for a viewpoint to be predicted, for the prediction viewpoint. In addition, the server 100 may generate a cost volume by stacking the warped images. In other words, the server 100 may convert reference images related to an adjacent viewpoint for the prediction viewpoint by warping the reference images using the depth information and the camera information (e.g., external camera parameter information) and may generate a cost volume by stacking the warped images. Since the cost volume is a set of images that have been converted on the basis of the same viewpoint, it is possible to detect as many identical points as possible by utilizing the cost volume.

According to various embodiments, the server 100 may generate an image having one channel on the basis of the generated cost volume. Referring to FIG. 11, the server 100 may generate an image having one channel by calculating a weighted sum of cost volumes in accordance with the distance between images.

According to the embodiment of the present invention, the method of recognizing an object of interest on the basis of multi-view images may include an operation S260 of setting a final object-of-interest region on the basis of cost volumes.

The operation of setting a final object-of-interest region may include an operation of correcting an outline in an image of the prediction viewpoint using a noise cancellation algorithm to set the final object-of-interest region. According to a more specific embodiment, an edge in a red-green-blue (RGB) image of the prediction viewpoint may be intensified through a joint bilateral filter provided in the Open-Source Computer Vision Library (OpenCV) package such that the final object-of-interest region may be set. The joint bilateral filter may be an algorithm for removing noise from a depth image. According to the embodiment, the joint bilateral filter may generate a joint histogram by applying a Gaussian function to brightness difference values of the color image of a reference pixel and its adjacent pixels and distance values between the pixels, and may remove noise from a depth image by filling the average value with the depth value of the reference pixel. In other words, as shown in FIG. 11, when an image having one channel that is related to a cost volume is processed as an input for the joint bilateral filter, noise may be removed from the image corresponding to the cost volume, which may contribute to improved accuracy in recognizing an object-of-interest region.

In other words, when a cost volume is generated by stacking images converted (or warped) on the basis of the same prediction viewpoint and an object-of-interest region is set on the basis of the generated cost volume, consistent object recognition is possible in various viewpoint images. This provides a consistent prediction result in accordance with multi-view images related to multiple viewpoints. In other words, it is possible to obtain consistent prediction results in accordance with multi-view images including images related to multiple viewpoints.

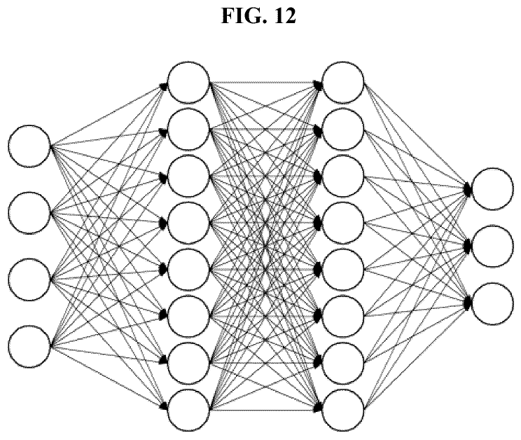

FIG. 12 is a schematic diagram illustrating one or more network functions according to an embodiment of the present invention.

Throughout the present specification, the terms “computation model,” “neural network,” and “network function” may be interchangeably used. A neural network may be configured as a set of interconnected calculation units which may be generally referred to as “nodes.” These “nodes” may also be referred to as “neurons.” A neural network includes one or more nodes. Nodes (or neurons) constituting neural networks may be interconnected by one or more “links.”

A deep neural network (DNN) may be a neural network including a plurality of hidden layers in addition to an input layer and an output layer. When a DNN is used, it is possible to recognize a latent structure of data. In other words, it is possible to recognize latent structures of photos, text, videos, voice, and music (e.g., what objects are in the photos, what the content and emotions of the text are, and what the content and emotions of the voice are). DNNs may include a CNN, a recurrent neural network (RNN), an auto encoder, a generative adversarial network (GAN), a restricted Boltzmann machine (RBM), a deep belief network (DBN), a Q network, a U network, a Siamese network, and the like. The foregoing DNNs are merely illustrative, and the present invention is not limited thereto.

A neural network may be trained using at least one of supervised learning, unsupervised learning, semi-supervised learning, and reinforcement learning. The training of a neural network is intended to minimize errors of an output. The training of a neural network is the process of repeatedly inputting training data to the neural network, calculating an error of an output of the neural network for the training data on the basis of a target, backpropagating the error of the neural network in a direction from an output layer to an input layer of the neural network to decrease errors, and thereby updating a weight of each node of the neural network. In the case of supervised learning, each piece of training data labeled with the ground truth (i.e., labeled training data) is used, and in the case of unsupervised learning, each piece of training data may not be labeled with the ground truth. In other words, for example, in the case of supervised learning for data classification, training data may be data of which each piece is labeled with a category. The labeled training data may be input to the neural network, and an output (category) of the neural network may be compared with the label of the training data to calculate an error. As another example, in the case of unsupervised learning related to data classification, training data which is an input may be compared with an output of the neural network to calculate an error. The calculated error is backpropagated in a reverse direction (i.e., the direction from the output layer to the input layer) in the neural network, and a connection weight of each node in each layer of the neural network may be updated with the backpropagation. A variation of the updated connection weight of each node may be determined in accordance with a learning rate. The calculation of the neural network for the input data and the backpropagation of the error may constitute a learning epoch. The learning rate is differently applicable in accordance with the number of repetitions of the learning epoch of the neural network. For example, at the initial learning stage of the neural network, a high learning rate may be used to make the neural network rapidly achieve a certain level of performance and improve efficiency, and at the latter learning stage, a low learning rate may be used to improve accuracy.

In the training of a neural network, training data may generally be a subset of actual data (i.e., data to be processed using the trained neural network). Accordingly, there may be a learning epoch in which errors in the training data are decreased but errors in the actual data are increased. Overfitting is a phenomenon in which training data is excessively learned and thus errors in real data increase. For example, a phenomenon in which a neural network that learns cats using orange cats does not recognize cats other than orange cats as cats may be overfitting. Overfitting may cause an increase in errors of a machine learning algorithm. To prevent overfitting, a method of increasing training data, regularization, a dropout method of omitting some nodes of a network during a training process, and the like may be employed.

Throughout the present specification, the terms “computation model,” “neural network,” and “network function” may be interchangeably used (hereinafter, collectively referred to as “neural network”). A data structure may include a neural network. The data structure including the neural network may be stored in a computer-readable medium. The data structure including the neural network may also include data input to the neural network, weights of the neural network, hyperparameters of the neural network, data obtained from the neural network, an activation function associated with each node or layer of the neural network, and a loss function for training the neural network. The data structure including the neural network may include any components from the disclosed configurations. In other words, the data structure including the neural network may include all of any combination of data input to the neural network, weights of the neural network, hyperparameters of the neural network, data obtained from the neural network, an activation function associated with each node or layer of the neural network, and a loss function for training the neural network. In addition to the foregoing elements, the data structure including the neural network may include any other information for determining a characteristic of the neural network. Further, the data structure may include all types of data used or generated in the computation process of the neural network, and is not limited to the foregoing matters. The computer-readable medium may include a computer-readable recording medium and/or a computer-readable transmission medium. The neural network may be composed of a set of calculation units which may be generally referred to as “nodes.” These “nodes” may also be referred to as “neurons.” The neural network includes one or more nodes.

The data structure may include data input to the neural network. The data structure including the data input to the neural network may be stored in the computer-readable medium. The data input to the neural network may include training data which is input during the training process of the neural network, and/or input data which is input to the neural network of which training has been completed. The data input to the neural network may include data that has undergone preprocessing and/or data to be preprocessed. The preprocessing may include a data processing process for inputting data to the neural network. Accordingly, the data structure may include data to be preprocessed and data generated by the preprocessing. The foregoing data structures are merely illustrative, and the present invention is not limited thereto.

The data structure may include a weight of the neural network (in the present specification, a weight and a parameter may be interchangeably used). Also, the data structure including the weight of the neural network may be stored in the computer-readable medium. The neural network may include a plurality of weights. The weights may be variable and may be varied by a user or an algorithm in order for the neural network to perform a desired function. For example, when one or more input nodes are connected to one output node by each of links, the output node may determine a data value output from the output node on the basis of values input to the input nodes connected to the output node and weights set for the links corresponding to each of the input nodes. The foregoing data structure is merely illustrative, and the present invention is not limited thereto.

As a non-limiting example, the weights may include weights varied in the neural network training process and/or weights of the neural network of which training has been completed. The weights varied in the neural network training process may include weights at a time at which a training cycle starts and/or weights varied during the training cycle. The weights of the neural network of which training has been completed may include weights of the neural network of which the training cycle has been completed. Therefore, the data structure including the weights of the neural network may include a data structure including the weights varied in the neural network training process and/or the weights of the neural network of which training has been completed. Accordingly, it is assumed that the above-described weights and/or a combination of the weights are included in the data structure including the weights of the neural network. The foregoing data structure is merely illustrative, and the present invention is not limited thereto.

The data structure including the weights of the neural network may be stored in the computer-readable storage medium (e.g., a memory or a hard disk) after undergoing a serialization process. The serialization may be the process of storing the data structure in the same computing device or a different computing device and converting the data structure into a form that may be reconstructed and used later. The computing device may serialize the data structure and transmit and receive the data through a network. The serialized data structure including the weights of the neural network may be reconstructed in the same computing device or a different computing device through deserialization. The data structure including the weights of the neural network is not limited to the serialization. Further, the data structure including the weights of the neural network may include a data structure (e.g., in the non-linear data structure, a B-tree, a Trie, an m-way search tree, an AVL tree, and a red-black Tree) for improving efficiency of the computation while minimally using the resources of the computing device. The foregoing matter is merely illustrative, and the present invention is not limited thereto.

The data structure may include hyperparameters of the neural network. The data structure including the hyperparameters of the neural network may be stored in the computer readable medium. The hyperparameters may be a variable varied by a user. The hyperparameters may include, for example, a learning rate, a cost function, the number of repetitions of the training cycle, weight initialization (e.g., setting of a range of a weight value to be initialized), and the number of hidden units (e.g., the number of hidden layers and the number of nodes in the hidden layers). The foregoing data structure is merely illustrative, and the present invention is not limited thereto.

Operations of a method or algorithm described regarding an embodiment of the present invention may be directly implemented as hardware, implemented as a software module executed by hardware, or implemented as a combination of the hardware and software module. The software module may be on a RAM, a ROM, an EPROM, an EEPROM, a flash memory, a hard disk, a detachable disk, a compact disc (CD)-ROM, or any type of computer-readable recording medium which is well known in the technical field to which the present invention pertains.

Components of the present invention may be implemented as a program (or an application) and stored in a medium to be executed in combination with a computer which is hardware. Components of the present invention may be implemented by software programming or software modules. Similarly, embodiments may be implemented in a programming or scripting language, such as C, C++, Java, an assembler, or the like, to include various algorithms implemented as data structures, processes, routines, or combinations of other programming elements. Functional aspects may be implemented using an algorithm that is executed by one or more processors.

Those skilled in the art of the present invention will understand that various exemplary logic blocks, modules, processors, means, circuits, and algorithm operations described in connection with the embodiments described herein may be implemented by electronic hardware, various forms of programs or design codes (for convenience, referred to as “software” herein), or a combination thereof. To clearly show the compatibility of hardware and software, a variety of illustrative components, blocks, modules, circuits, and operations have been generally described in connection with functions thereof. Whether these functions are implemented by hardware or software is related to a particular application and design constraints of the whole system. Those skilled in the art can implement the function described in a variety of ways for each specific application, but the decision of the implementation should not be construed as departing from the scope of the present invention.

The variety of embodiments set forth herein may be implemented as articles manufactured using methods, apparatuses, or standard programming and/or engineering techniques. The term “manufactured article” includes a computer program, a carrier, or a medium accessible by any computer-readable device. Examples of a computer-readable medium may include, but are not limited to, magnetic storage devices (e.g., a hard disk, a floppy disk, a magnetic strip, and the like), optical discs (e.g., a CD, a digital video disc (DVD), and the like), smart cards, and flash memory devices (e.g., an EEPROM, a card, a stick, a key drive, and the like). In addition, the variety of storage media presented herein include one or more devices for storing information and/or other machine-readable media. The term “machine-readable media” includes, but is not limited to, wireless channels and various other media for storing, retaining, and/or transmitting instruction(s) and/or data.

It should be understood that the specific order or hierarchical structure of operations of each of the presented processes is an example of exemplary approaches. It should be understood that a specific order or hierarchical structure of operations of processes within the scope of the present disclosure may be rearranged on the basis of design priorities. The appended method claims provide elements of various operations in a sample order but should not be construed as being limited to the specific order or hierarchical structure presented herein.

Description of the embodiments set forth herein is provided to help those of ordinary skill in the art use or implement the present invention. It will be obvious to those of ordinary skill in the technical field of the present invention that various modifications can be made from these embodiments, and the general principles defined herein may be applied to other embodiments without departing from the scope of the present invention. Therefore, the present invention is not limited to the embodiments set forth herein but should be construed in the broadest scope consistent with the principles and novel features presented herein.

### Modes of the Invention

The relevant description has been provided in Best M ode of the Invention.

### INDUSTRIAL APPLICABILITY

The present invention can be utilized in fields related to 3D rendering images.

1. A method of generating a cube map from a plurality of images related to multiple viewpoints that is performed by at least one processor of a computing device, the method comprising:
acquiring a plurality of images taken from various viewpoints with a specific object centered;
acquiring an object mask and camera information corresponding to each of the plurality of images through preprocessing of the image;
acquiring a plurality of background images each corresponding to the plurality of images on the basis of the object mask corresponding to each of the images;
acquiring depth information on the basis of the plurality of background images and camera information corresponding to each of the background images; and
acquiring a cube map on the basis of the plurality of background images, the camera information corresponding to each of the background images, and the depth information.

2. The method of claim 1, wherein the plurality of images include multiple viewpoint images acquired by utilizing one camera, and
each of the images is an image taken to at least partially overlap adjacent images related to adjacent viewpoints.

3. The method of claim 1, wherein the acquiring of the object mask and the camera information corresponding to each of the plurality of images through the preprocessing of the image comprises:
extracting a feature point from each of the plurality of images;
matching the extracted feature point with an adjacent image;
acquiring initial camera information corresponding to each of the images on the basis of the matching points; and
optimizing the initial camera information to acquire the camera information corresponding to each of the images.

4. The method of claim 1, wherein the acquiring of the object mask and the camera information corresponding to each of the plurality of images through the preprocessing of the image comprises extracting an object mask related to the specific object from each of the images by utilizing an algorithm based on deep learning.

5. The method of claim 1, wherein the acquiring of the depth information on the basis of the plurality of background images and the camera information corresponding to each of the background images comprises extracting depth information corresponding to each of the background images by utilizing a multi-view stereo (MVS) algorithm, and
the depth information includes information related to distances from a camera to objects included in each of the images.

6. The method of claim 1, wherein the acquiring of the cube map comprises:
projecting the plurality of background images to a three-dimensional (3D) space on the basis of the camera information corresponding to each of the background images and the depth information; and
acquiring the cube map on the basis of the plurality of background images projected to the 3D space.

7. The method of claim 6, wherein the acquiring of the cube map on the basis of the plurality of background images projected to the 3D space comprises:
converting coordinates corresponding to each point in the 3D space into spherical coordinates corresponding to a spherical coordinate system; and
generating a cube map on the basis of the spherical coordinates of each point and a pixel value corresponding to the point.

8. The method of claim 1, further comprising correcting the cube map,
wherein the correcting of the cube map comprises:
identifying a missing region in the cube map; and
calculating missing pixel values on the basis of adjacent pixel values of the missing region and complementing the missing region using the missing pixel values.

9. A server comprising:
a memory configured to store one or more instructions; and
a processor configured to execute the one or more instructions stored in the memory,
wherein, by executing the one or more instructions, the processor performs the method of claim 1.

10. A computer-readable recording medium storing a program for executing, by a computing device, a method of generating a cube map from a plurality of images related to multiple viewpoints, the method comprising:
acquiring a plurality of images taken from various viewpoints with a specific object centered;
acquiring an object mask and camera information corresponding to each of the plurality of images through preprocessing of the image;
acquiring a plurality of background images each corresponding to the plurality of images on the basis of the object mask corresponding to each of the images;
acquiring depth information on the basis of the plurality of background images and camera information corresponding to each of the background images; and
acquiring a cube map on the basis of the plurality of background images, the camera information corresponding to each of the background images, and the depth information.
